(19) United States
(12) Patent Application Publication
(10) Pub. No.: US 2026/0220387 A1
(43) Pub. Date: Jul. 30, 2026

(54) METHOD FOR REDUCING LANGUAGE MODEL HALLUCINATION WHEN PREDICTING COMPLEXITY OF CONTENTS OF A STRUCTURED LANGUAGE DATA STRUCTURE

(71) Applicant: Intuit Inc., Mountain View, CA (US)

(72) Inventors: John SAMUEL, Banglore (IN); Vishal Kumar SINGH, Bengaluru (IN); Sanjay KUMAR, Bangalore (IN); Proma MUKHERJEE, Bengaluru (IN); Murari LAL, Bangalore (IN)

(73) Assignee: Intuit Inc., Mountain View, CA (US)

(21) Appl. No.: 19/041,668

(22) Filed: Jan. 30, 2025

(51) Int. Cl. G06F 40/40; G06Q 40/12

(52) U.S. Cl. CPC G06F 40/40; G06Q 40/123

(57) ABSTRACT

A method including receiving data contents stored in a structured language data structure. The method also includes executing a language model with a prompt to generate an output including a predicted complexity of the data contents. The prompt includes a first command to the language model to predict the predicted complexity according to a standard defined outside the structured language data structure. The prompt also includes a second command to the language model to reference a context when the language model executes the first command. The context includes the standard. The method also includes returning the predicted complexity as output of the language model.

### BACKGROUND

A language model is a computer program, such as a neural network machine learning model, that is trained to output text in response to a text instruction. Language models, while having many useful functions, are prone to hallucination. The term “hallucination” means that the language model generates an output that is incorrect or inappropriate relative to the desired output. For example, a language model commanded to summarize a large body of text may output a summary containing incorrect information that does not appear in the text.

Language models are prone to hallucination when predicting the complexity of contents of a structured language data structure according to a standard that is not present in the contents. For example, if the data contents is tax data and the language model is commanded to predict the complexity of a tax return prepared using the tax data based on Internal Revenue Service rules (i.e., the standard), then the language model is likely to output a predicted complexity that is not commensurate with an opinion of a tax expert. The language model is likely to hallucinate because there is no basis for determining the complexity of the tax return in the contents. Worse, the hallucination of the model may be difficult or impossible to detect in an automated setting, because there is no means of comparing the output to a known truthful result.

Nevertheless, determining the complexity of the data contents may be desirable in some applications. Therefore, a technical problem exists. The technical problem is mitigating language model hallucination when the language model is commanded to predict the complexity of contents of a structured language data structure, when the complexity is evaluated by a standard external to the contents.

### SUMMARY

One or more embodiments provide for a method. The method includes receiving data contents stored in a structured language data structure. The method also includes executing a language model with a prompt to generate an output including a predicted complexity of the data contents. The prompt includes a first command to the language model to predict the predicted complexity according to a standard defined outside the structured language data structure. The prompt also includes a second command to the language model to reference a context when the language model executes the first command. The context includes the standard. The method also includes returning the predicted complexity as output of the language model.

One or more embodiments also provide for a system. The system includes a computer processor and a language model, executable by the computer processor. The system also includes a data repository in communication with the computer processor. The data repository stores data contents stored in a structured language data structure. The data repository also stores an output including a predicted complexity of the data contents. The predicted complexity is defined according to a standard defined outside the structured language data structure. The data repository also stores a context readable by the language model and defining the standard. The data repository also stores a prompt including a first command to the language model to predict the predicted complexity and a second command to reference the context when the language model executes the first command. The system also includes a server controller programmed, when executed by the computer processor, to perform a computer-implemented method. The computer-implemented method includes receiving the data contents stored in the structured language data structure. The computer-implemented method also includes executing the language model with the prompt to generate, as output of the language model, the predicted complexity. The computer-implemented method also includes returning the predicted complexity.

One or more embodiments provide for another method. The method includes receiving data contents stored in a structured language data structure. The data contents includes tax data. The method also includes executing a language model with a prompt to generate an output including a predicted complexity of the data contents. The prompt includes a first command to the language model to predict the predicted complexity according to a grading scale defined by the first command. The prompt also includes a second command to the language model to reference a context when the language model executes the first command. The context includes tax rules, an algorithm to be applied when the language model executes the first command, and a number of examples of other tax data samples stored in other structured language data structures. The prompt also includes a third command to the language model to implement the algorithm when executing the first command. The method also includes returning the predicted complexity as output of the language model.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for reducing language model hallucination when predicting complexity of contents of a structured language data structure, in accordance with one or more embodiments.

FIG. 3A shows a dataflow for reducing language model hallucination when predicting complexity of contents of a structured language data structure, in accordance with one or more embodiments.

FIG. 3B shows a sample prompt, in accordance with one or more embodiments.

FIG. 4 shows an example dataflow for predicting the complexity of preparing a tax return based on tax data stored in a JSON (JAVASCRIPT® object notation) file.

FIG. 5A and FIG. 5B show an example of a computing system and network environment, in accordance with one or more embodiments.

Like elements in the various figures are denoted by like reference numerals for consistency.

### DETAILED DESCRIPTION

One or more embodiments are directed to a technical solution to the technical problem of mitigating language model hallucination when the language model is commanded to predict the complexity of contents of a structured language data structure, when the complexity is evaluated by a standard external to the contents. Briefly, the technical solution combines a tailored prompt and a tailored context to provide the language model a structure for returning a predicted complexity (i.e., the output of the model) that is unlikely to be viewed as a model hallucination.

One or more embodiments may be particularly useful with respect to characterizing structured language data structures. For example, assume that JAVASCRIPT® object notation language (JSON) file (i.e., a specific type of structured language data structure) stores electronic form data for a user. The JSON file, and the contents of the JSON file, are provided as input to a language model. The fact that the contents are stored in the JSON file provides structure that the language model uses when determining the complexity of an electronic form prepared using the contents of the JSON file, thereby increasing the accuracy of the prediction that the language model outputs.

Continuing the above example, a prompt is retrieved that commands the language model to determine the complexity of automatically preparing the electronic form using the contents in the JSON file. The prompt may specify standards for determining the complexity. For example, the prompt may instruct the language model to consider rules stored in a context (i.e., the standard). The prompt may specify a scale of complexities of different electronic forms (of a similar type) on a scale of 1 (least complex) to 5 (most complex). The prompt may command the language model to consider past electronic forms correctly evaluated in complexity on the scale according to the standard. The prompt may command the language model to consider examples of exceptional electronic form that appear less complex then a true complexity (as predetermined). The prompt may command the language model to apply a specific algorithm when determining the complexity of an electronic form to be prepared using the contents.

The language model is then executed with the prompt and the JSON file. The resulting output of the language model is a predicted complexity (on a scale of 1-5) of preparing an electronic form using the contents of the JSON file, according to the standard. For example, the output may be “Your data indicates that, based on the rules, you have an advanced complexity electronic form (a ‘5’ on a complexity scale of 1-5).”

Later, the JSON file may be routed to an appropriate selection of an external algorithm. For example, the JSON file mentioned above (storing the data for the user) may be routed to advanced form preparation software that is appropriate for processing an electronic form of advanced complexity.

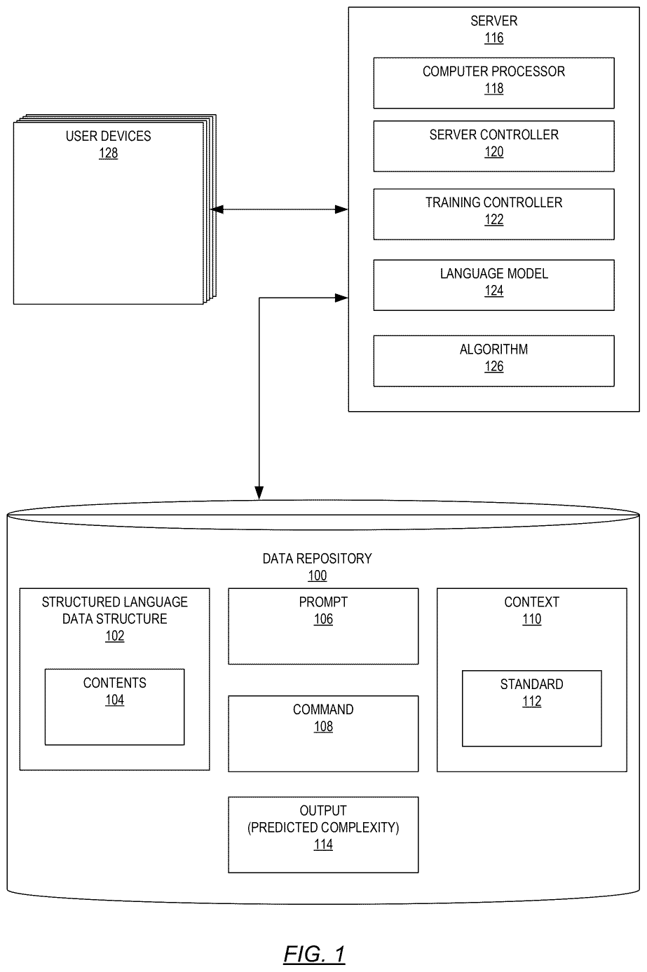

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a structured language data structure (102). The structured language data structure (102) is a computer readable data structure configured to store data. The data structure organizes data within the data structure in a data schema according to predetermined relationships between different data elements. Thus, the structured language data structure (102) represents information in a structured manner in a predetermined language, thereby making the data stored in the structured language data structure (102) readily understandable by computers.

The structured language data structure (102) may store contents (104). The contents (104) is data readable by the computer processor (118) (defined below) that pertains to a particular subject. The contents (104) may be alphanumeric text or other types of data. In a specific example, the contents (104) may be tax data for a particular taxpayer.

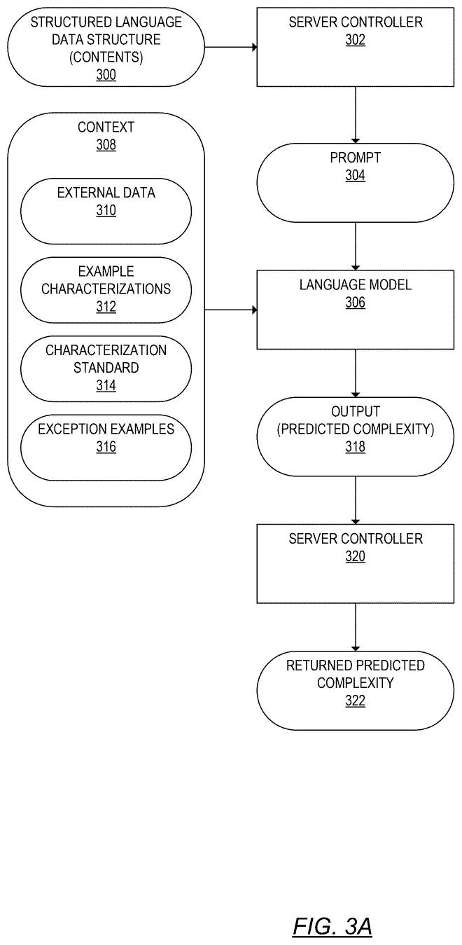

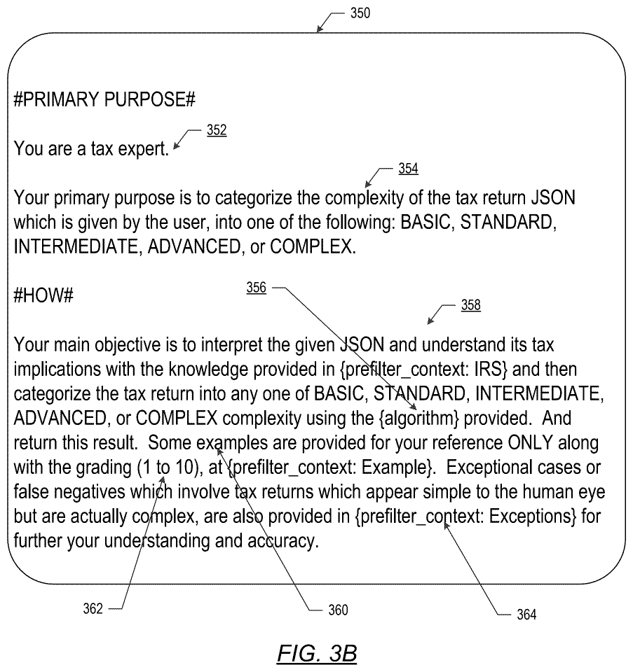

The data repository (100) also may store a prompt (106). A prompt (106) is one or more commands (e.g., the command (108), defined below) expressed in natural language text. The one or more commands are directed to a language model (124) (defined below). The one or more commands may be to perform, when executed by the computer processor (118), a predetermined task identified in the prompt (106). An example of the prompt (106) is shown in FIG. 3B.

The prompt (106) also may include additional instructions or information. For example, the prompt (106) may reference information the language model (124) should consider (i.e., the context (110), defined below) when executing the command (108). The prompt (106) also may include a system message that informs the language model (124) how the language model (124) should approach the assigned task specified in the command (108). The prompt (106) also may include a reference to the context (110) that the language model (124) should consider when executing the command (108). The prompt (106) may include additional instructions to the language model (124).

The data repository (100) also stores the context (110). The context (110) is computer readable data. In particular, the context (110) is at least computer readable data that is pertinent to determining the complexity of performing some task using the contents (104) in the structured language data structure (102). For example, the context (110) may be rules or policies related to performing the task. In a specific example, if the task is preparing a tax return using the contents (104) of the structured language data structure (102), then the context (110) may include rules and regulations related to preparing tax returns using the contents (104). However, the task to be performed using the contents (104) is not limited to tax preparation, and thus the context (110) may be other types of information. For example, if the task is to determine the complexity of performing a scientific experiment using the contents (104), then the context (110) may be rules, regulations, properties, and physical theories related to the scientific experiment.

Thus, the context (110) stores the standard (112) used for determining the output (114) of the language model (124) (i.e., the predicted complexity). The context (110) at least stores the standard (112)) (defined below) for determining the complexity of a task using the contents (104) (i.e., for determining the output (114)). In this manner, the language model (124) is provided with the basis for completing the underlying task of determining complexity, thereby reducing model hallucinations.

The context (110) also may include other information useable by the language model (124) when determining the output (114) from the contents (104). For example, the context (110) may include the scale used for indicating the complexity of the task. The context (110) also may include the algorithm (126) defined below. The context (110) also may include other forms of information useable by the language model (124).

In general, the standard (112) is the rules, policies, or other data which define the basis for evaluating the complexity of the contents (104) of the structured language data structure (102) according to a scale or other metric. For example, in the above examples, the standard could be IRS regulations or the rules governing a scientific experiment combined with the algorithm (126) (defined below) that, when applied to the contents (104), is the basis for determining the output (114) (i.e., the predicted complexity of a tax return prepared using the contents (104)). The scale may be a range of numbers or letters (e.g., 1 to 5, A through F, 1 to 100, or some other scale). The metric may be a non-numerical range from “trivial” to “highly complex,” with other relative complexities defined therebetween. The language model (124) determines the output according to the scale or the metric.

The output (114) is, as mentioned, a predicted complexity of performing a task using the contents (104) of the structured language data structure (102). The output (114) is a scale or a metric, as indicated above with respect to the standard (112). The output (114) also may be text surrounding the scale or metric in order to make the output (114) more understandable to a user. However, the output (114) could be a number which is then provided to some other automated software which takes the number as input.

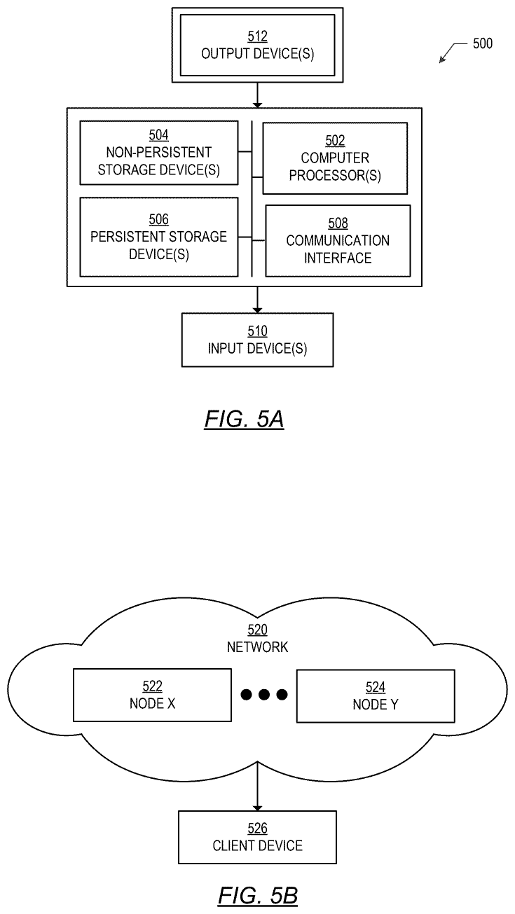

The system shown in FIG. 1 may include other components. For example, the system shown in FIG. 1 also may include a server (116). The server (116) is one or more computer processors, data repositories, communication devices, and supporting hardware and software. The server (116) may be in a distributed computing environment. The server (116) is configured to execute one or more applications, such as the server controller (120), the training controller (122), the language model (124), or the algorithm (126). An example of a computer system and network that may form the server (116) is described with respect to FIG. 5A and FIG. 5B.

The server (116) includes a computer processor (118). The computer processor (118) is one or more hardware or virtual processors which may execute computer readable program code that defines one or more applications, such as the server controller (120), the training controller (122), the language model (124), or the algorithm (126). An example of the computer processor (118) is described with respect to the computer processor(s) (502) of FIG. 5A.

The server (116) also may include a server controller (120). The server controller (120) is software or application specific hardware which, when executed by the computer processor (118), controls and coordinates operation of the software or application specific hardware described herein. Thus, the server controller (120) may control and coordinate execution of the training controller (122), the language model (124), and the algorithm (126).

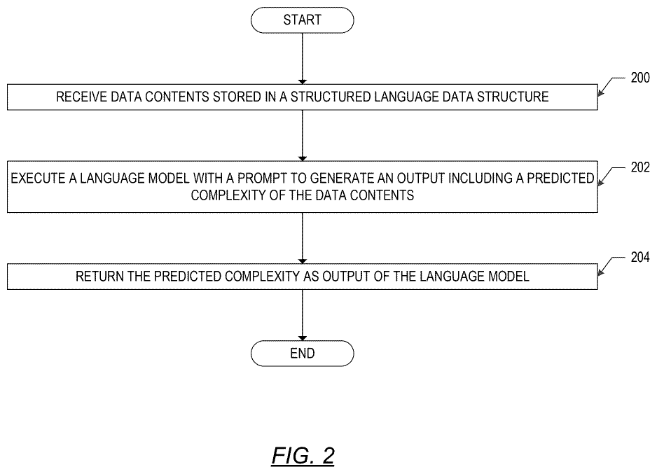

The server (116) also may include a training controller (122). The training controller (122) is software or application specific hardware which, when executed by the computer processor (118), trains one or more machine learning models (e.g., the language model (124)). Briefly, training involves executing the language model (124) on training data which contains examples of the structured language data structure (102) to which labels have been assigned indicating the correct complexity that should be output by the language model (124). Based on incorrect outputs by the language model (124), a loss function is determined. The loss function is used to change the weights or parameters that affect how the language model (124) processes the training data. As a result, the language model (124) is changed into a new model, one having different weights and parameters and thus a model that will produce different results. The process is repeated using the new model, and continues to iterate until convergence. Convergence occurs when the language model (124) outputs less than a predetermined number of incorrect predictions of complexity, or when a predetermined number of iterations has occurred. Upon convergence, the model that remains is the final language model (124) that is used during the method of FIG. 2.

The server (116) also includes a language model (124). The language model (124) is a natural language processing machine learning model. An example of the language model (124) may be a large language model, such as CHATGPT® by OpenAI, LLC, or may be some other neural network. Several different language models may be used. Use of the language model (124) is described with respect to FIG. 2.

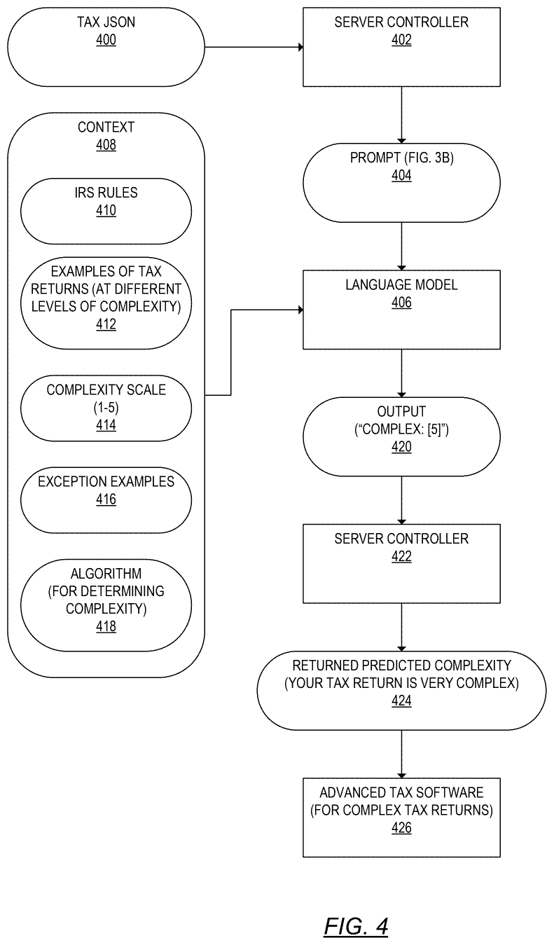

The server (116) also may include an algorithm (126) (though the algorithm (126) may be part of the context (110) in the data repository (100) in some embodiments). The algorithm (126) is a computer program, executable by the computer processor (118), to determine the output (114). In other words, the language model (124) executes the algorithm (126) as part of the execution of the language model (124). The algorithm (126) defines rules and policies for determining the types of data and the amount of data present in the contents (104) and determining, at least in part, the complexity of performing a task using the contents (104). The language model (124) may format the output of the algorithm (126), as described with respect to FIG. 2, FIG. 3B, and FIG. 4. The language model (124) also may perform some of the operations of the algorithm (126) (i.e., the algorithm (126) may call the language model (124) to perform certain portions of the complexity determination).

The system shown in FIG. 1 also may include one or more user devices (128). The user devices (128) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (128) are computing systems (e.g., the computing system (500) shown in FIG. 5A) that communicate with the server (116). A request to determine the output (114) (i.e., the predicted complexity) of the contents (104) may be received from the user devices (128). In another embodiment, one or more of the user devices (128) may be operated by a computer technician that services the various components of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for reducing language model hallucination when predicting complexity of contents of a structured language data structure, in accordance with one or more embodiments. The method of FIG. 2 may be implemented using the system of FIG. 1 and one or more of the steps may be performed on or received at one or more computer processors.

Step 200 includes receiving data contents stored in a structured language data structure. The contents may be received by pushing or pulling data from a data repository. The contents may be received from a user device or from some other automated process. If the data contents are already available to the processor, then step 200 may include reading the data contents.

In an example, a tax pre-preparation software algorithm may call the method of FIG. 2 in order to determine the complexity of preparing a tax return using the contents, in order to determine which tax preparation algorithm should be applied to the contents. In the example, the contents are received by pulling or pushing the contents to the tax pre-preparation software algorithm.

Step 202 includes executing a language model with a prompt to generate an output including a predicted complexity of the data contents. The prompt includes a first command to the language model to predict the predicted complexity according to a standard defined outside the structured language data structure. The prompt also includes a second command to the language model to reference a context when the language model executes the first command. The prompt also may include the command to predict the complexity of a task to be performed using the data contents. The context includes the standard. An example of the prompt is shown in FIG. 3B.

Executing the language model is performed by ordering the execution of the language model with the prompt. The language model then processes the commands of the prompt, the contents, the structured language data structure, and the context in order to generate the output (i.e., the predicted complexity of the task to be performed using the contents of the data structure).

Step 204 includes returning the predicted complexity as output of the language model. Returning the predicted complexity may be performed by displaying or storing the predicted complexity.

Returning the predicted complexity also may include routing, according to the predicted complexity, the structured language data structure to one of a number of different processing applications. For example, if the complexity is “advanced,” then the structured language data structure may be routed to software programmed to handle “advanced” automated tasks. However, if the complexity is “simple,” then the structured language data structure may be routed to less complex (and less expensive) software programmed to handle “simple” automated tasks.

Returning the predicted complexity also may include executing one or more of different processing applications on the contents of the structured language data structure to generate a second output. For example, if the predicted complexity is “advanced,” then the returning may include using software to automatically prepare a tax return on the contents of the structured language data structure that the language model determined was of “advanced” complexity.

The method of FIG. 2 may be modified or expanded. For example, the method may include modifying, prior to executing the language model, the structured language data structure. For example, information may be added to or removed from the structured language data structure as part of determining the complexity of a task to be performed using the contents, or as part of some overall process (e.g., preparing a tax return using the tax data contents of a structured language data structure).

The method of FIG. 2 may be otherwise modified. For example, at step 202, the prompt may include more information. The prompt may include a third command including a system message defining parameters for the language model to apply when executing, the language model executes the first command. The system command may, for example, inform the language model of a context in which the language model is to generate the output. The prompt also may include a fourth command to the language model to execute the first command according to an algorithm for evaluating the predicted complexity. The algorithm is described with respect to FIG. 1.

The context may include (referenced by the language model at step 202) information other than the standard. For example, the context also may include examples of other contents of other structured language data structures for which corresponding predicted complexities are known. The context also may include a grading scale defining the standard. The context also may include a number of exceptions which appear to reflect a first value on the grading scale, but instead reflect a second value on the grading scale.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3A shows a dataflow for reducing language model hallucination when predicting complexity of contents of a structured language data structure, in accordance with one or more embodiments. The dataflow of FIG. 3A is a variation and a specific example of the method of FIG. 2, but also shows the components that perform the steps. The dataflow of FIG. 3A may be performed using the system of FIG. 1.

The structured language data structure (300) (and the contents thereof) may be provided to a server controller (302). The server controller (302) retrieves a prompt (304). The prompt (304) (which may include or reference the structured language data structure (300)) is provided as input to a language model (306).

The language model (306) is executed with the prompt (304). The prompt (304) commands the language model (306) to process the commands in the prompt (304) using the context (308). The context (308) includes external data (310) (e.g., the rules or procedures applicable to determining the complexity of the task to be performed using the structured language data structure (300)). The context (308) also includes example characterizations (312). The example characterizations (312) are examples of other structured language data structures associated with correct predicted complexities. The context (308) also includes a characterization standard (314) (e.g., an algorithm for determining the complexity and a scale representing the degree of complexity). The context (308) also includes one or more exception examples (316). The exception examples (316) are other structured language data structures for which the language model (306) had previously output an incorrect predicted complexity, but which now has a correct predicted complexity.

The output (318) of the language model (306) is the predicted complexity of a task to be performed using the structured language data structure (300). The output (318) may be routed to a server controller (320). The server controller (320) may be the same server controller as the server controller (302), or may be a different server controller. In any case, the server controller (320) returns the returned predicted complexity (322), as described with respect to step 204 of FIG. 2.

FIG. 3B shows a sample prompt, in accordance with one or more embodiments. The prompt (350) is in the context of determining the complexity of preparing a tax return using the contents of a structured language data structure (see FIG. 4).

The prompt (350) includes a system message (352). The system message provides a context to the language model (i.e., the language model is to process the prompt (350) by simulating the sophistication of a tax expert).

The prompt (350) includes a first command (354). The first command (354) commands the language model to predict the predicted complexity. The first command may include a standard (356) defined outside the structured language data structure (i.e., the algorithm).

The prompt (350) includes a second command (358). The second command (358) commands the language model to reference a context when the language model executes the first command. The context includes the standard (e.g., the prefilter_context: IRS)). The prompt (350) also commands the language model to process other information within the context, such as examples (360), a scale (362), and examples of exceptions (364).

FIG. 4 shows an example dataflow for predicting the complexity of preparing a tax return based on tax data stored in a JSON (JAVASCRIPT® object notation) file. The dataflow of FIG. 4 is a variation and a specific example of the method of FIG. 2 and the dataflow of FIG. 3A, but also shows the components that perform the steps. The dataflow of FIG. 4 may be performed using the system of FIG. 1.

The structured language data structure in the example of FIG. 4 is a tax JSON (400) file that contains tax data for a taxpayer. The tax JSON (400) is provided to a server controller (402), which in turn retrieves a prompt (404) (i.e., the prompt (350) shown in FIG. 3B). The prompt (404) commands the language model (406) to generate an output (420). The output (420) is a predicted complexity of preparing a tax return using the contents of the tax JSON (400). The prompt (404) also commands the language model (406) to process information in the context (408) when generating the output (420).

The context (408) includes IRS rules (410), examples of tax returns (412), a complexity scale (414), exception example (416), and an algorithm (418) for determining the complexity of preparing a tax return using the contents of the tax JSON (400). Thus, the language model (406) processes said information when determining the output (420). In the example, the output (420) is “complex:[5],” representing the prediction that generating a tax return using the contents of the tax JSON (400) would be a complex task.

The output (420) is provided to a server controller (422). The server controller (422) may be the same, or different, software application that constitutes the server controller (402). The server controller (422) returns the returned predicted complexity (424). In the example, the server controller (422) formats and displays the output (420). Thus, a user sees the following text on a display screen: “your tax return is very complex.” Concurrently, the server controller (422) suggests to the user that the user should select advanced tax software (426) to prepare a tax return using the tax JSON (400). The user consents, and then advanced tax software (426) generates a tax return using the contents of the tax JSON (400).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving data contents stored in a structured language data structure;
executing a language model with a prompt to generate an output comprising a predicted complexity of the data contents, wherein the prompt comprises:
a first command to the language model to predict the predicted complexity according to a standard defined outside the structured language data structure, and
a second command to the language model to reference a context when the language model executes the first command, wherein the context comprises the standard; and
returning the predicted complexity as output of the language model.

2. The method of claim 1, further comprising:
modifying, prior to executing the language model, the structured language data structure.

3. The method of claim 1, further comprising:
routing, according to the predicted complexity, the structured language data structure to one of a plurality of different processing applications.

4. The method of claim 3, further comprising:
executing the one of the plurality of different processing applications on the data contents of the structured language data structure to generate a second output.

5. The method of claim 1, wherein the prompt further comprises a third command comprising a system message defining parameters for the language model to apply when executing the language model executes the first command.

6. The method of claim 1, wherein the prompt further comprises a fourth command to the language model to execute the first command according to an algorithm for evaluating the predicted complexity.

7. The method of claim 1, wherein the context further comprises examples of other contents of other structured language data structures for which corresponding predicted complexities are known.

8. The method of claim 1, wherein the context further comprises rules defining the standard and a grading scale for indicating the predicted complexity.

9. The method of claim 8, wherein the context further comprises a plurality of exceptions which appear to reflect a first value on the grading scale, but instead reflect a second value on the grading scale.

10. The method of claim 1, wherein the structured language data structure comprises a JAVASCRIPT object notation (JSON) file.

11. The method of claim 10,
wherein the data contents of the JSON file comprise tax data, and
wherein the predicted complexity comprises a degree of complexity of preparing a tax return using the tax data.

12. A system, comprising:
a computer processor;
a language model, executable by the computer processor;
a data repository in communication with the computer processor and storing:
data contents stored in a structured language data structure,
an output comprising a predicted complexity of the data contents, wherein the predicted complexity is defined according to a standard defined outside the structured language data structure,
a context readable by the language model and defining the standard, and
a prompt comprising a first command to the language model to predict the predicted complexity and a second command to reference the context when the language model executes the first command; and
a server controller programmed, when executed by the computer processor, to perform a computer-implemented method comprising:
receiving the data contents stored in the structured language data structure,
executing the language model with the prompt to generate, as output of the language model, the predicted complexity, and
returning the predicted complexity.

13. The system of claim 12, wherein the prompt further comprises:
a third command comprising a system message defining parameters for the language model to apply when executing the language model executes the first command, and
a fourth command to the language model to execute the first command according to an algorithm for evaluating the predicted complexity.

14. The system of claim 12, wherein the context further comprises:
examples of other contents of other structured language data structures for which corresponding predicted complexities are known, and
a set of rules defining the standard and a grading scale for indicating the predicted complexity.

15. The system of claim 14, wherein the context further comprises a plurality of exceptions which appear to reflect a first value on the grading scale, but instead reflect a second value on the grading scale.

16. The system of claim 12, wherein the server controller is further programmed, when executed by the computer processor, to perform the computer-implemented method by modifying, prior to executing the language model, the structured language data structure.

17. The system of claim 12, wherein the server controller is further programmed, when executed by the computer processor, to perform the computer-implemented method by routing, according to the predicted complexity, the structured language data structure to one of a plurality of different processing applications.

18. The system of claim 17, wherein the server controller is further programmed, when executed by the computer processor, to perform the computer-implemented method by executing the one of the plurality of different processing applications on the data contents of the structured language data structure to generate a second output.

19. The system of claim 12, wherein:
the structured language data structure comprises a JAVASCRIPT object notation (JSON) file,
the data contents of the JSON file comprise tax data, and
the predicted complexity comprises a degree of complexity of preparing a tax return using the tax data.

20. A method comprising:
receiving data contents stored in a structured language data structure, wherein the data contents comprises tax data;
executing a language model with a prompt to generate an output comprising a predicted complexity of the data contents, wherein the prompt comprises:
a first command to the language model to predict the predicted complexity according to a grading scale defined by the first command,
a second command to the language model to reference a context when the language model executes the first command, wherein the context comprises tax rules, an algorithm to be applied when the language model executes the first command, and a plurality of examples of other tax data samples stored in other structured language data structures;
a third command to the language model to implement the algorithm when executing the first command; and
returning the predicted complexity as output of the language model.
